(19) United States
(12) Patent Application Publication
(10) Pub. No.: US 2017/0065984 A1
(43) Pub. Date: Mar. 9, 2017

(54) SYSTEM AND METHOD FOR AUTOMATED FOAM FRACTIONATOR OPTIMIZATION

(71) Applicant: Ali Jason Behzad, Huntington Beach, CA (US)

(72) Inventor: Ali Jason Behzad, Huntington Beach, CA (US)

(21) Appl. No.: 15/259,993

(22) Filed: Sep. 8, 2016

Related U.S. Application Data
(60) Provisional application No. 62/215,557, filed on Sep. 8, 2015.

(51) Int. Cl. B03D 1/02; C02F 1/00; B01D 21/00; C02F 1/24

(52) U.S. Cl. CPC B03D 1/028; C02F 1/24; C02F 1/008; B01D 21/0084

(57) ABSTRACT

The present invention generally involves a system and method for optimizing foam fractionator, which is automated to improve precision in monitoring and adjustment control, as well as increase cost efficiency via a plurality of sensors and a control module. In one embodiment, a system for automated fractionation may include a vessel, a pump including a motor for delivering feed fluid to the vessel, one or more sensors for generating sensing data within the vessel, and a control module configured to receive sensing signals from the one or more sensors, and generate a command signal to control the motor of the pump in response to the sensing signals.

### PRIORITY NOTICE

The present application claims priority under 35 U.S.C. §119(e) to U.S. Provisional Patent Application Ser. No. 62/215,557 filed on Sep. 8, 2015, the disclosure of which is incorporated herein by reference in its entirety.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### TECHNICAL FIELD OF THE INVENTION

The present invention relates in general to a system and method for automated foam fractionator optimization, and more specifically, to a foam fractionation or foam separation system that may be automated and optimized via a plurality of sensors and a control module to improve precision in monitoring and adjustment control, as well as increase efficiency.

### BACKGROUND OF THE INVENTION

Devices for foam separation, including froth flotation and foam fractionation devices have been utilized in various industries. For example, fractionation systems are currently used in the mining, pharmaceutical, and waste-water treatment industries. Known uses include applications for agriculture, aquaculture, fish farming, fish breeding systems, as well as marine invert grow and breeding systems—to name a few. The primary purpose of these systems is typically to extract an undesired from a mixture or medium, or to concentrate a desired in a solution or emulsion.

One type of fractionation technique is known as foam fractionation, or skimming, which comprises the process of separating hydrophobic and amphiphilic compounds from a polarized solution. A foam fractionator—the device used to remove the targeted compounds from the polarized solution—typically employs a containment vessel wherein an air-water interface is achieved by injecting air into a column of water, which results in production of pneumatic foam (i.e. raising); this foam is then collected and extracted.

For example, FIG. 1 depicts a prior art fractionator 100 commonly used as a skimmer. These devices include a container or vessel, such as vessel 101 with a lower container 102 configured to receive the influx of incoming water (i.e. feed water 103) from a water source, which is mixed with the injected air and introduced into the vessel by a pump 104. Typically, the incoming feed water is processed through the vessel, extracting and discharging the target material into a collection container 105 or directly into a waste system (i.e. where the target material is undesired). The resulting effluent becomes a medium including a lower concentration of the targeted materials. The air-water interface 102a attracts the compounds, situating them based on their polarity within the surface of the bubble (of the foam that forms). As the foam rises up the vessel's column 106, the foam enriches further through contact with feed water 103. The rising bubbles change in viscosity causing them to increase in size. The rise of the air-water mixture will also cause drainage of the liquid in between the bubbles and further condense the foam (i.e. known as foam-mate or skimmate). The condensed foam or foam-mate is further enriched with proteins and other hydrophobic/amphiphilic particles and compounds. This action continues resulting in thicker foam-mate higher up the column of the vessel. Naturally, as the foam-mate rises and becomes more devoid of water its characteristics change—for example, conductivity decreases and its resistance increases. In the final step of the process, the enriched foam-mate cascades over into the collection container and is discharged from the system and (in some systems) the effluent exits the skimmer returning back to the system filtered.

To accommodate the process above, a feed water delivery and gas or air injection mechanism is required. Many different methods of accomplishing these tasks have been introduced in different industries, such as: using air pumps and diffusers, aspirating pumps, Venturi structures, down-draft methods, and other techniques. Naturally, depending on the applications of the fractionation system, different metrics may be used to monitor and control the system.

The problem with known methods and devices such as the system shown in FIG. 1, is that in order to achieve the desired metrics, manual adjustment is regularly required. For example, changes in the system's chemistry, redox, temperature, salinity can affect the desired metrics and will require the user to perform continuous adjustments and monitoring, which must be conducted manually.

Although some prior art devices have attempted some measure of automation, these are inadequate. For example, use of rudimentary float sensors have enabled designers to integrate a shut-off fail-safe to some protein skimmer designs. This means, in case the collection container is full and about to overflow, the float sensor trips and shuts the feed water delivery pump. Although effective in basic concept, this method requires constant maintenance and it is not fail-proof. The mechanical float ball is often restricted of motion by organic particle build up, resulting in rendering the fail-safe device useless.

Therefore, there is a need in the art for a means to automate a fractionation system. Moreover, it is desirable that automation be achieved so as to improve precision in monitoring and adjustment control, as well as increase cost efficiency.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a foam fractionation or foam separation system that may be automated and optimized via a plurality of sensors and a control module, which implements one or more sets of instructions to improve precision in monitoring and adjustment control, as well as increase cost efficiency.

A method performed by a control module for optimizing foam fractionation, in accordance with practice of one embodiment of the present invention, comprises: driving a pump motor to inject feed fluid into a fractionation vessel at an initial speed; receiving sensing signals from a plurality of sensors configured to detect a fluid level of a fluid medium within the fractionation vessel; continuously adjusting a speed of the motor in response to the sensing signals from the plurality of sensors; maintaining the fluid level of the fluid medium at a predetermined distance from a collection compartment of the fractionation vessel; and disabling at least one of the plurality of sensors for facilitating a foam to rise from the fluid medium into the collection compartment.

A system for optimizing foam fractionation, in accordance with one embodiment of the present invention, comprises: a fractionation vessel; a pump including a motor for delivering feed fluid to the vessel; a plurality of sensors configured to detect a fluid level of a fluid medium within the fractionation vessel; and a control module configured to: drive the pump motor to inject the feed fluid into the fractionation vessel at an initial speed; receive sensing signals from the plurality of sensors; continuously adjust a speed of the motor in response to the sensing signals from the plurality of sensors; and disable at least one of the plurality of sensors for: maintaining the fluid level of the fluid medium at a predetermined distance from a collection compartment of the fractionation vessel, and facilitating a foam to rise from the fluid medium into the collection compartment.

A method performed by a control module for optimizing foam fractionation, in accordance with practice of one embodiment of the present invention, comprises: driving a pump motor to inject feed fluid into a fractionation vessel at an initial speed; receiving sensing signals from a plurality of sensors configured to detect a fluid level of a fluid medium within the fractionation vessel; receiving a time-based parameter associated with the fluid level of the fluid medium inside the fractionation vessel; continuously adjusting a speed of the motor in response to: the sensing signals from the plurality of sensors, or the time-based parameter associated with the fluid level of the fluid medium; and disabling at least one of the plurality of sensors for: facilitating a foam to rise from the fluid medium into the collection compartment; and maintaining the fluid level of the fluid medium at a predetermined distance from a collection compartment of the fractionation vessel.

It is an objective of the present invention to provide automation of a fractionating system.

It is another objective of the present invention to provide a system that uses sensing data and a control module to optimize fractionation.

It is yet another objective of the present invention to improve monitoring precision for fractionation systems.

It is yet another objective of the present invention to improve adjustment control for fractionation systems.

It is yet another objective of the present invention to increase cost efficiency of fractionation systems.

It is yet another objective of the present invention to provide a fractionation system that implements automated failsafe controls.

These and other advantages and features of the present invention are described herein with specificity so as to make the present invention understandable to one of ordinary skill in the art.

### BRIEF DESCRIPTION OF DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1 depicts a prior art fractionator commonly used as a skimmer.

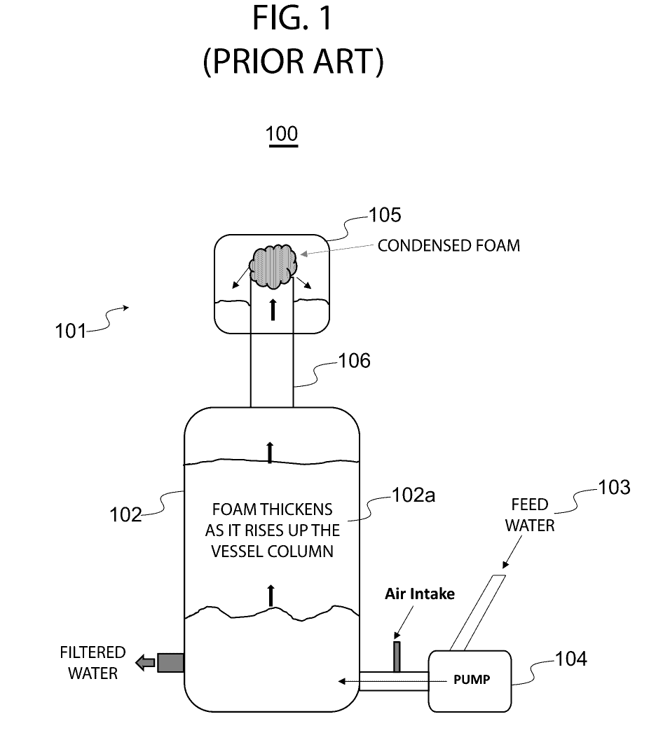

FIG. 2 depicts a system in accordance with an exemplary embodiment of the present invention.

FIG. 3 depicts a flowchart describing a method in accordance with practice of an embodiment of the present invention.

FIG. 4 depicts a system in accordance with an exemplary embodiment of the present invention.

FIG. 5 is a flow chart illustrating an exemplary method in accordance with practice of one embodiment of the present invention.

### DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Generally, the present invention involves a foam fractionation or separation system that may be automated and optimized via a plurality of sensors and a control module configured to control components of the system such as a motorized pump. As will be detailed below, several types of configurations may be possible depending on the type of metrics the system will require, as well as the types of sensors and sensing data employed by the system. The control module may be configured to receive sensing data from the plurality of sensors, which may be placed in accordance with a travel flow in order to aid the control module to make determinations based on the flow of the fluid and/or foam moving through the fractionation vessel. Depending on the sensing data, the control module can make adjustments to the motor, to valves, or components of the fractionator system. For example, and without limiting the scope of the present invention, the controller or control module may control the motor of the pump in order to increase, decrease, or maintain motor speed (i.e. revolutions per minute), the motor's torque, or acceleration. A set of executable instructions may be implemented by the control module in order to keep the system optimized based in part on the sensing data output from the plurality of sensors.

In the following disclosure, several process efficacy factors, characteristics, parameters or metrics may be used. These may be defined metrics that measure foam fractionation efficacy of different systems. The metrics disclosed herein are merely exemplary, and any other metrics may be incorporated without deviating from the scope of the present invention. Such metrics may measure or quantify skimming, extraction rates, or otherwise measure a skimmer's performance; for example, and without limiting the scope of the present invention, the following metrics may be considered: enrichment, recovery, bubble size, gas injection, turbulence, or any other set of parameters, characteristics or factors that may be useful in optimizing a fractionator system.

Enrichment (E) may be defined as the ratio of surfactant concentration in the “skim-mate” (i.e. collapsed foam head discharged into the collection cup) to the feed water. Recovery (R) may be defined as the percentage of the surfactants removed within a specified time. To measure enrichment and or recovery, different means may be employed by a system in accordance with the present invention. For example, a system in accordance with the present invention may measure or account for: bubble size; gas injection; gas flow rate; or turbulence.

Bubble size may be indicative of the system's performance where target molecules are trapped on the surface of the bubble. As such, the smaller the bubbles the more the surface area to trap contaminants. Hence, autonomously determining the bubble size, and or adjusting the bubble size may be useful to optimize a fractionator system.

Similarly, a gas injection method and the velocity of the gas injected can affect the bubble size. Typically, the higher velocity will make for smaller bubbles. Moreover, higher gas flow rate will increase recovery and decrease enrichment. As such, monitoring and adjusting the velocity or gas flow rate of a gas injected in a fractionator system may be desirable.

Turbulence may also be monitored. While design measures should be taken to eliminate excess turbulence, which can reduce the rate of bubble coalescence, certain amount of turbulence within the lower portion of the vessel may increase the contact time of the bubbles with feed water resulting in increased enrichment. While recovery is not affected by the same degree it is slightly elevated by minimal amount of turbulence present. Hence, it may be desirable to monitor and adjust the turbulence of a fractionator system as well in order to optimize results.

To monitor and adjust the metrics mentioned above, different means may be employed. For example, and without deviating from the scope of the present invention, a protein skimmer typically requires adjustment to reflect the actual saturation rate of the dissolved organic compounds (DOC) in the feed water. If the rate of the gas injection is higher than the existing amount of DOC required to be exported (which often results in poor operations or overflowing of the feed water into the collection container) adjustment of the fractionator is required. Adjustment may be achieved by: restricting the water input; restricting the gas input; or manipulating the air-water interface height on the vessel. Additionally, considering the final purpose of a particular skimming process, whether it being extraction or concentration, a protein skimmer may be adjusted to skim “dry” (i.e. wherein the skim-mate contains less water) or “wet” (the skim-mate contains more water).

By implementing a control module configured to receive sensing signals or data from a plurality of sensors throughout the vessel of the skimmer, the fractionator may be automatically adjusted. That is, upon detecting any changes that have an effect on the surface tension of the bubbles, conductivity of the medium and/or saturation of the DOCs in the feed water, or any other changes, the control module may control one or more components in order to maintain a desired metric—as will be discussed below, one of the components that may be controlled is the motor of the pump to help maintain desired parameters.

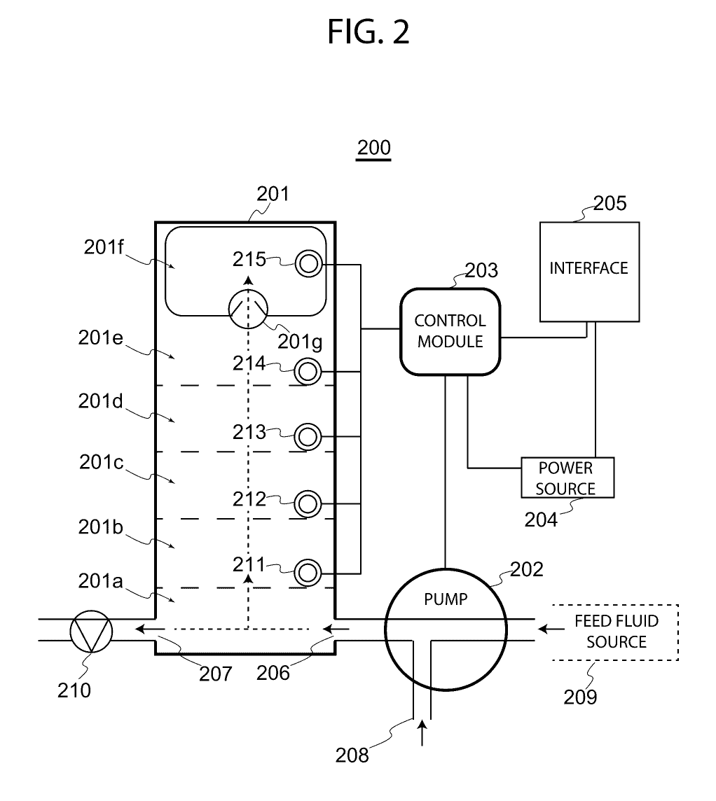

Turning now to the figures describing the invention, FIG. 2 depicts a system in accordance with an exemplary embodiment of the present invention. More specifically, FIG. 2 shows system 200, which includes vessel 201, pump 202, control module 203, power source 204, user interface 205, and a plurality of sensors 211, 212, 213, 214 and 215.

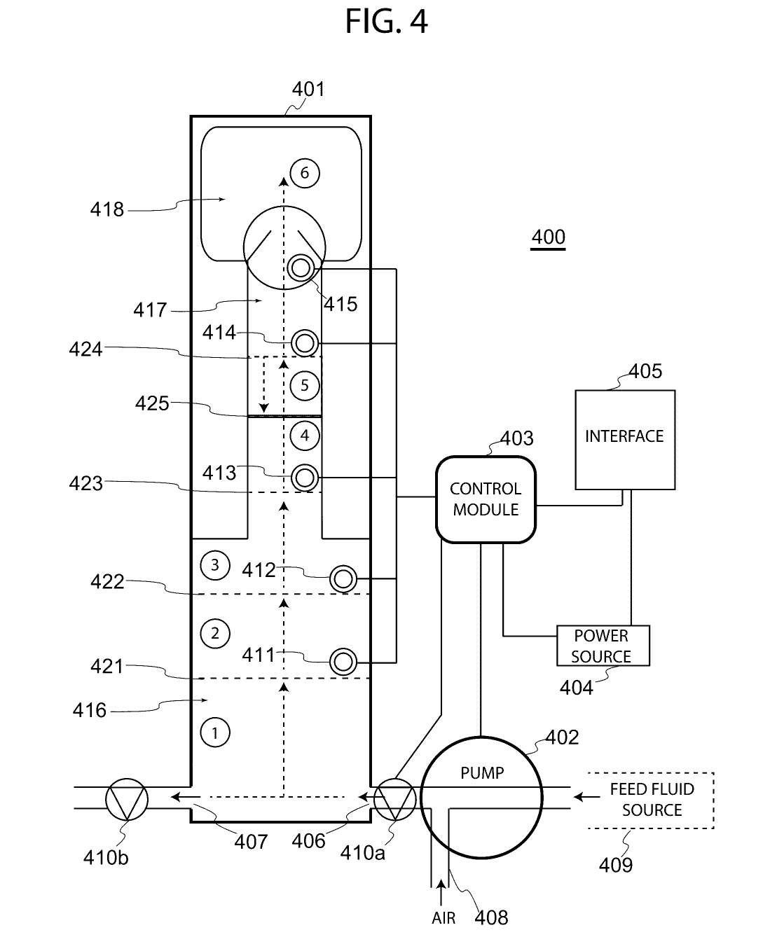

Typically, vessel 201 may be constructed to include a column or vertical structure that enables the foam created in the air-fluid interface to rise so as to deposit the foam within its containment vessel or collection compartment (i.e. 2010. Hence, in exemplary embodiments, vessel 201 includes intake 206, output 207, and a series of sections 201a-201e configured in a way so as to allow foam to rise—for example, in a vertical arrangement. More specifically, section 201a may be a bottom portion of vessel 201 where intake 206 allows a flow of feed fluid such as water to enter vessel 201. Section 201b may be a section of vessel 201 wherein an air-fluid interface may enable foam to form and rise along the vessel column. Sections 201c and 201d may form a middle portion of the columned vessel whereby a narrowing channel such as shown in FIG. 4 (i.e. 416) may be incorporated. Notably, any known vessel model or known configuration commonly utilized by fractionator systems may be implemented with system 200 without deviating from the scope of the present invention. Generally, sections 201b-201e are designed for the air-fluid interface (i.e.) with section 201e including component 201g, which may be a device or structural component that controls the flow of fluid between the lower sections of vessel 201 and collection container 201f; this prevents skimmate from falling back into the lower sections of vessel 201. Such components or structures are well known in the art; as such, collection container 201f is configured to receive the skimmate formed when the system is running.

Vessel 201 may be constructed of a wide variety of materials without deviating from the scope of the present invention, and constructed to receive a feed fluid (e.g. feed water) via intake 206, allowing the feed fluid to exit vessel 201 via output 207 so that the air-water interface may be sustained. Control valve 210 may control feed fluid that exits or flows out of vessel 201.

Pump 202 injects the air-water mixture by delivering water from feed fluid source 209 and air from intake 208 into vessel 201. In exemplary embodiments, pump 202 includes a motor, which may be an electronically commutated (ECM) motor, or DC motor such as a brushless DC (BLDC) motor with variable speed and/or torque control capabilities. BLDC may be desirable as this technology offers ease of control and more cost efficiency. BLDC technology provides a wide variety of control, adjustment, as well as protein skimmer fail-safes functions. Furthermore, regulating RPM and torque on BLDC driven pumps is much simpler and can be regulated by a microprocessor controlled system or PLC (via control module 203 discussed below). Of course, other types of motorized pumps may be incorporated with system 200 including AC motors; however whatever motor pump 202 employs, typically the motor is configured for variable speed and/or torque control capabilities.

Sensors 211, 212, 213, 214, and 215 may be positioned within vessel 101 to gather information pertaining to the metrics or parameters of system 200. For example, these sensors may be capacitance sensors, optic sensors or proximity sensors, ultrasonic sensors, mechanical float sensors, or a variety of other types of sensors or transducers configured to read one or more parameters suitable for generating sensing data pertaining to system 200. Typically, sensors 211-215 are configured to generate a sensing signal or sensing data pertaining to a relevant parameter and send the sensing signal or data to control module 203 for processing. In one exemplary embodiment, sensor 211-215 are positioned at different locations within vessel 201 to coincide with a particular air-water mixture or foam state. For example, and without limiting the scope of the present invention: sensor 211 may be positioned at a lower portion of section 201b where mostly water is expected during operation of system 200; sensor 212 may be positioned at section 201c and sensor 213 may be positioned at section 201d where foam is typically expected to form during operation of system 200; sensor 214 may be positioned at section 201e where foam may be expected to be thicker and less water is present in the mixture; and sensor 215 may be positioned in collection container 201f of vessel 201 where extraction material is typically deposited.

In such configuration, the sensors may be adapted to provide outputs concerning factors that take account of or are helpful in determining enrichment and/or recovery. The sensing signals or sensing data may provide a means to measure or monitor for: bubble size, gas injection, gas flow rate, turbulence, water level, feed fluid flow speed, feed fluid level, or any other number of parameters or metrics that will enable control module 203 to optimize system 200's operation. For example, factors such as atmospheric pressure differences, air-water interface and/or foam level, or conductivity may be monitored and then utilized by a control module in order to keep the system functioning at an optimum.

Control module 203 may be configured to control one or more components of system 200. In exemplary embodiments, control module 203 is configured to draw power from power source 204 and supply power to pump 202 in order to drive the pump's motor. As such, control module 203 is typically configured to control one or more parameters of pump 202—for example, and without limiting the scope of the present invention, control module 203 may control the speed or revolutions per minute (RPMs) of pump 202, the acceleration of pump 202, the torque of pump 202, or any other parameter that may be useful in controlling a system parameter. In exemplary embodiments, control module 203 may be configured to control pump 202 in order to monitor and adjust the feed fluid flow rate as well as the level of fluid that may be desired inside vessel 201, or height of the air-water interface, depending on the feedback or output received from sensors 211-215. There are multiples of options and technologies available to manipulate a motor's speed, its RPMs, acceleration, and/or torque through analog or digital signal—for example, controlling the pump via pulse width modulation (PWM). Analog control such as voltage variation (many such motors employ 0-10V dimming), as well as integrated digital control (within more advanced BLDC Motor controllers) are both possibilities. Considering the BLDC platform and its robust capabilities of control and manipulation of RPM/Torque relationship, an automated fractionator system such as system 200 may be regulated and controlled by means of different sensors placed within the skimmer vessel whereby different parameters can be monitored. Accordingly, control module 203 is typically configured to communicate with sensors 211-215 in order to monitor the parameters of system 200.

Control module 203 may be configured to communicate with sensors 211-215 via wired or wireless means without deviating from the scope of the present invention. As such, control module 203 typically includes one or more processors or microprocessors configured to receive sensing signals or sensing data from sensors 211-214 and generating one or more command signals in response to the sensing signals or data. One or more sets of instructions or executable program code concerning desired metrics may be programmed into a memory of control module 203.

For example, and without deviating from the scope of the present invention different factors and multilateral parameters can be considered, defined and introduced to regulate and monitor the activities of an automated foam fractionator such as dry and wet skimming.

In one exemplary embodiment, control module 203 is configured to communicate with sensors 211-215, wherein the plurality of sensors comprise of conductivity sensors. In another exemplary embodiment, control module 203 is configured to communicate with sensors 211-115, wherein the plurality of sensors comprise of optical proximity sensors. In yet another exemplary embodiment, control module 203 is configured to communicate with sensors 211-215, wherein the plurality of sensors comprise of ultrasonic sensors.

Different embodiments of the present invention may utilize different components. For example:

### Exemplary Embodiment Using Capacitance Sensors

In some industries and some design variation, operating a protein skimmer presents the chance of overflowing and flooding the holding facility due to different reasons. In this situation, overflowing in definition will be explained as excessive cascading of the feed water unprocessed into the collection container. In most instances the volume of the collection container is extremely minute compared to that of the actual system's volume the protein skimmer is employed on. This means in the event of an overflow, the possibility of filling the collection container and flooding the holding room is inevitable.

An automated protein skimmer in accordance with the present invention can monitor, gauge and regulate many different parameters to employ this failsafe in the skimming process. In this instance, a fail-safe function maybe performed via monitoring the discharged medium and feed water conductivity.

Upon detecting an overflow event, the control module may generate a signal to, for example, stop operation of the pump. Additionally, constant monitoring of vessel via sensors will provide the control module with parameters pertaining to the conductivity of each section of the air-water interface as well as the foam within the vessel. Because each phase of the air water/foam mixture has a specific conductivity range, the control module may keep the flow of feed water and air at a desired or optimum level.

In such embodiment, control module 203 may be configured to drive the pump motor to inject the feed fluid into the fractionation vessel at an initial speed; receive sensing signals from the plurality of sensors; continuously adjust a speed of the motor in response to the sensing signals from the plurality of sensors; and disable at least one of the plurality of sensors for: maintaining the fluid level of the fluid medium at a predetermined distance from a collection compartment of the fractionation vessel, and facilitating a foam to rise from the fluid medium into the collection compartment. A more detailed explanation of this or similar embodiment is discussed with reference to FIG. 4 below.

### Exemplary Embodiment Using Optical or Ultrasonic Proximity Sensors

In another exemplary embodiment, automatic skimmer shut-off may be implemented using proximity sensors. Typically, manual operation of the valve allows for control of skimming dry or skimming wet. In the event that there is a power outage, manual operation of the valve is required. In this embodiment, optical or ultrasonic proximity sensors may be utilized to facilitate this function. A method that may be practice utilizing ultrasonic sensors or optical proximity sensors is discussed in turn.

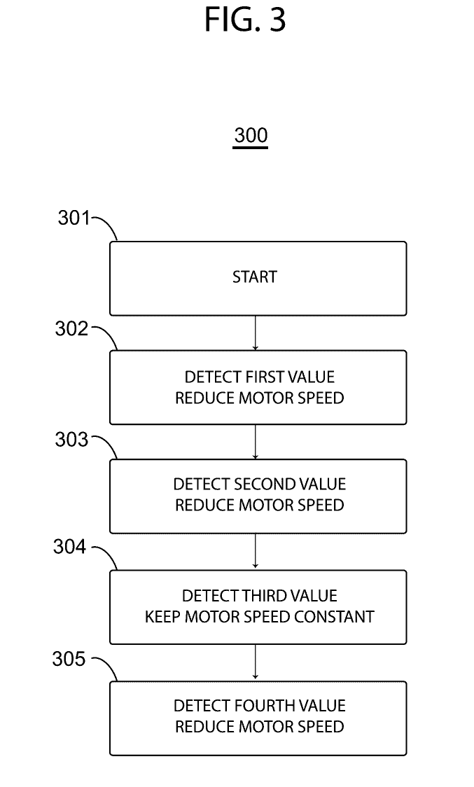

For purposes of illustrating an algorithm that may be programmed into control module 203, method 300 for autonomous control of a fractionator system is disclosed with reference to the next figure. FIG. 3 depicts a flowchart describing method 300 in accordance with practice of one embodiment of the present invention. Although method 300 is shown in a particular sequence of steps, it should be noted that method 300 may be practiced in alternative sequence or variations thereof, without deviating from the scope of the present invention.

In step 301, the fractionator may be started. In an exemplary embodiment, and for illustrative purposes, the fractionator of system 200 may be a protein skimmer. As such, the protein skimmer of system 200 may be initiated at step 301 whereby a user may access control module 203 via user interface 205 and activate, or otherwise cause the control module to start driving pump 202 to begin injecting feed water from feed source 209 into vessel 201. In this step, control module 203 may start to drive pump 202 at a first speed or acceleration and feed water that enters vessel 201 at a lower section 201a will start to rise up the column of vessel 201.

In step 302, as the water level rises on vessel 201 and the feed water fills section 201a, sensor 211 may detect the feed water level and provide to control module 203 a sensing signal or sensing data including a first value or information pertaining to the height of the feed water within vessel 201. In one embodiment, in response to receiving the sensing signal including the first value, control module 203 may further reduce the acceleration of pump 202 but allowing the water level in section 201b to continuously rise.

In step 303, as the water level rises on vessel 201 and the feed water fills section 201b, sensor 212 may detect the feed water level and provide, to control module 203, a sensing signal or sensing data including a second value or information pertaining to the height of the feed water within vessel 201. In one embodiment, in response to receiving the sensing signal including the second value, control module 203 may adjust the speed of the motor by for example further reducing the acceleration of pump 202 but allowing the water level in section 201c to continuously rise.

In step 304, as the water level rises in vessel 201 and the feed water fills section 201c, sensor 213 may detect the feed water level and provide, to control module 203, a sensing signal or sensing data including a third value or information pertaining to the height of the feed water within vessel 201. In one embodiment, in response to receiving the sensing signal including the third value, control module 203 may maintain a speed of pump 202 keeping the RPMs of pump 202 constant, still allowing the water level to rise.

In step 305, as the water level rises on vessel 201 and the feed water fills section 201d, sensor 214 may detect the feed water level and provide, to control module 203, a sensing signal or sensing data including a fourth value or information pertaining to the height of the feed water within vessel 201. In one embodiment, in response to receiving the sensing signal including the fourth value, control module 203 may decrease a speed or an acceleration of pump 202 but allowing the water level in section 201c to continuously rise, reducing the RPMs of pump 202.

In an exemplary embodiment, sensor 214 of vessel 201 may be utilized as a security measure or fail-safe measure, whereby a sensing signal from sensor 214 may signal control module 203 to execute a security protocol or fail-safe algorithm. Alternatively, other sensors (211-215) may evoke a security or fail-safe protocol, whereby an acceleration of pump 202 may be reduced, increase, or maintained. Similarly, the RPMs of the pump 202 may be reduced, maintained, or the motor stopped in case of an emergency.

For example, and without deviating from the scope of the present invention, in one embodiment, control module 203 may include executable instructions that take into account known data such as: the distance between sensors 211-215; the speed of the motor of pump 202; the acceleration of the motor of pump 202; or the expected time at which the water level may reach fill lines for sections 201a-201e of vessel 201. With this information, various algorithms may be implemented in order to keep the feed water level at a desired optimum during the fractionation process.

Turning now to the next figure, FIG. 4 depicts a system in accordance with an exemplary embodiment of the present invention. More specifically, FIG. 4 shows an exemplary embodiment including one or more sensors throughout the vessel column in a manner consistent with that shown in FIG. 2 particularly showing where the sensors may be placed within the vessel.

FIG. 4 shows fractionation system 400, including vessel 401, pump 402, control module 403, power source 404, user interface 405, and a plurality of sensors 411, 412, 413, 414 and 415.

System 400 comprises fractionation vessel 401; pump 402 including a motor for delivering feed fluid to the vessel; a plurality of sensors 411, 412, 413, 414 and 415 configured to detect a fluid level of a fluid medium within the fractionation vessel; and a control module 403 configured to: drive the pump motor to inject the feed fluid into the fractionation vessel at an initial revolutions per minute (RPM); receive sensing signals from the plurality of sensors; continuously adjust the RPM of the motor in response to the sensing signals from the plurality of sensors; maintain the fluid level of the fluid medium at a predetermined distance from a collection compartment of the fractionation vessel; and disable at least one of the plurality of sensors for facilitating a foam to rise from the fluid medium into the collection compartment 418. Similarly, control module 403 may be configured to: drive the pump motor to inject the feed fluid into the fractionation vessel at an initial speed; receive sensing signals from the plurality of sensors; continuously adjust a speed of the motor in response to the sensing signals from the plurality of sensors; and disable at least one of the plurality of sensors for: maintaining the fluid level of the fluid medium at a predetermined distance from a collection compartment of the fractionation vessel, and facilitating a foam to rise from the fluid medium into the collection compartment.

As with the embodiment of system 200, system 400 includes a plurality of sensors situated vertically along a column or vertical structure of vessel 401, which enables the foam created in the air-fluid interface to rise so as to deposit the foam within collection compartment 418. As such, vessel 401 typically includes intake 406, output 407, a lower compartment 416 (where the air-fluid interface is created and allowed to rise) and an upper compartment 417 or narrower or narrowing portion that connects lower portion 416 to collection compartment 418. Notably, any known vessel model or known configuration commonly utilized by fractionator systems may be implemented with system 400 without deviating from the scope of the present invention.

Coupled to vessel 401 (internally or externally to lower portion 416 and upper portion 417), are a plurality of sensors 411-414. In such exemplary embodiment, sensors 411-414 may be placed so as to mark particular fill-lines for a fluid level within vessel 401, a particular distance from collection compartment 418, or other similar metrics associated with the fluid that enters vessel 401. This is desirable because optimization of the extraction/collection process often depends (at least in part) on the position of the fluid line in relation to the collection compartment—since the foam generated by the air-fluid interface rises from the fluid line into the collection compartment.

Accordingly, system 400 may include a first sensor 411 situated within the fractionation vessel 401, configured to generate or output sensing signals concerning a first fluid level 421 of the feed fluid within the fractionation vessel 401, wherein control module 403 is configured to reduce the initial speed or RPM of the motor in response to the sensing signal from sensor 411 in order to drive pump 402 at a first speed or RPM value that is lower than the initial speed or RPM of the motor, but sufficient to continue to cause the fluid level to rise within vessel 401.

System 400 may further include a second sensor 412 situated within fractionation vessel 401 and above sensor 411, the sensing signals from sensor 412 concerning a second fluid level 422 within fractionation vessel 401, wherein control module 403 is further configured to reduce the first RPM value in response to the sensing signal from sensor 412 in order to drive pump 402 at a second RPM value that is lower than the first RPM value—sufficient to continue to cause the fluid level to rise within vessel 401 towards fluid level 423.

System 400 may further include a third sensor 413 situated within a narrowing channel or upper portion 417 of fractionation vessel 401 and above sensor 412, the sensing signals from sensor 413 concerning a third fluid level 423 within fractionation vessel 401, wherein control module 403 is further configured to reduce the third RPM value in response to the sensing signal from the third sensor in order to drive pump 402 at a fourth RPM value that is lower than the second RPM value—sufficient to continue to cause the fluid level to rise within vessel 401 towards fluid level 424.

System 400 may further include a fourth sensor 414 situated within a narrowing channel or upper portion 417 of fractionation vessel 401 and above sensor 413, the sensing signals from sensor 414 concerning a fourth fluid level 424 within fractionation vessel 401, wherein control module 403 is further configured to reduce the fourth RPM value in response to the sensing signal from the fourth sensor in order to drive pump 402 at a fifth RPM value that is lower than the third RPM value—sufficient to continue to cause the fluid level to rise within vessel 401 towards fluid level 424.

Typically, control module 403 is configured to disable the fourth sensor 413 after a predetermined period of time for maintaining the fluid level at the predetermined distance from the collection compartment of the fractionation vessel. Moreover, the control module 403 may be configured for driving the pump at a constant speed in order to maintain the fluid level above sensor 413 but below sensor 414. It may be desirable to switch off, disable, or otherwise disregard sensor 414 once an optimum fluid level line is reached (for example fluid level 425) so that once foam starts to form and rise along upper portion 417, the foam does not inadvertently signal control module 403 to decrease or otherwise change the motor's RPM, speed, or acceleration in any way.

System 400 may further include safety-sensor 415 situated in proximity to collection compartment 418 of fractionation vessel 401, sensor 415 configured to detect the fluid medium but disregard the foam created, wherein control module 403 is further configured to gradually decrease the RPM of the motor in response to the one or more signals from safety-sensor 415 to lower the fluid level of the fluid medium to a threshold level within fractionation vessel 401—or stop the motor all together in order to prevent an overflow. This safety sensor may be coupled to the collection compartment of the fractionation vessel and configured to detect the fluid medium and disregard the foam, wherein the control module is further configured to gradually decrease the speed of the motor in response to the one or more signals from the safety-sensor to lower the fluid level of the fluid medium to a threshold level within the fractionation vessel.

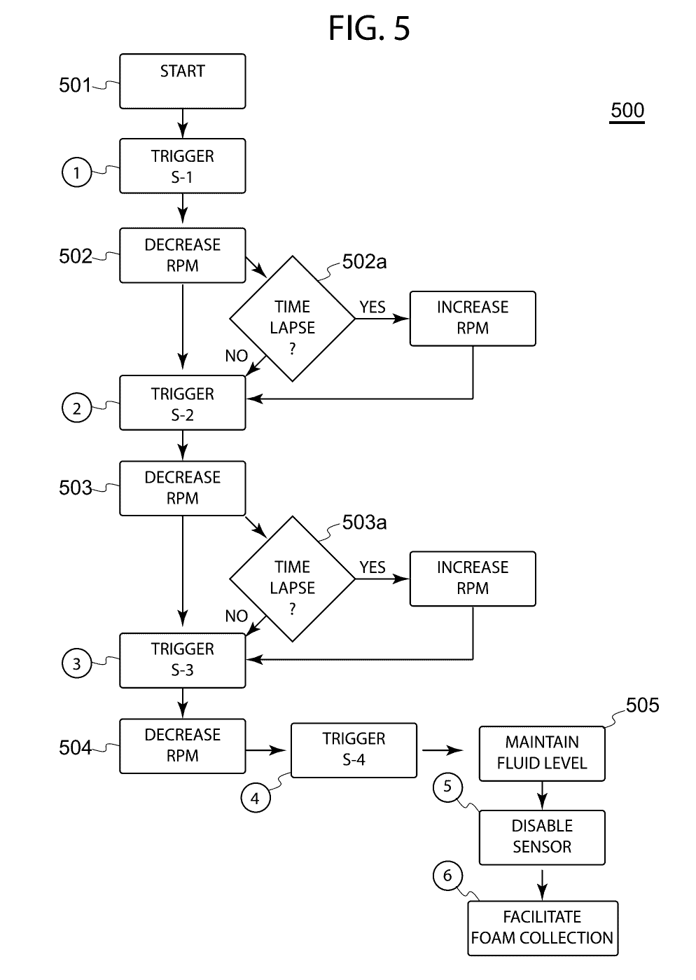

FIG. 5 depicts a flowchart describing method 500 in accordance with practice of one embodiment of the present invention—performed by a control module for optimizing foam fractionation. Although method 500 is shown in a particular sequence of steps, it should be noted that method 500 may be practiced in alternative sequence or variations thereof, without deviating from the scope of the present invention.

With reference to FIGS. 5 and 4 the process may start at step 501 by activating control module 403 to start to drive pump 402 to inject feed fluid from feed fluid source 409 into fractionation vessel 401 at an initial speed or revolutions per minute (RPM). In step (1), the control module may receive one or more sensing signals from a first sensor situated within the fractionation vessel, the sensing signals from the first sensor concerning a first fluid level 421 of the feed fluid within the fractionation vessel 401.

In step 502, control module 403 may reduce the initial speed or RPM of the motor in response to the sensing signal from the first sensor in order to drive the pump at a first speed or RPM value that is lower than the initial speed or RPM of the motor until a second fluid level such as fluid level 422 is reached (or sensor 412 detects that the fluid has reached level 422).

In the interim (step 502a), some embodiments may implement a preprogrammed time limitation whereby if the fluid fails to reach fluid level 422 during the pre-set length of time, then control module 403 may momentarily and gradually increase the motor's speed or RPM in order to reach fluid level 422 more quickly. Accordingly, in step 502a, such determination may take place whereby if the time limitation has lapsed control module 403 may gradually increase the speed or RPMs of the pump 402. Alternatively, if the time limitation does not lapse and instead the fluid reaches fluid level 422 within the pre-set length of time, the control module 403 does not momentarily increase the motor's speed or RPMs.

In step (2), control module 403 may receive one or more sensing signals from a second sensor 412 situated within the fractionation vessel 401, the sensing signals from the second sensor concerning a second fluid level 422 of the feed fluid within the fractionation vessel.

In step 503, control module 403 may reduce the speed or RPM of the motor in response to the sensing signal from sensor 412 in order to drive the pump at a speed or RPM value that is lower than the previous speed or RPM value until a third fluid level such as fluid level 423 is reached (or sensor 413 detects that the fluid has reached level 423).

As in the previous steps, some embodiments may implement a preprogrammed time limitation. Accordingly, in step 503a, such determination may take place whereby if the time limitation has lapsed control module 403 may gradually increase the speed or RPMs of the pump 402. Alternatively, if the time limitation does not lapse and instead the fluid reaches fluid level 423 within the pre-set length of time, the control module 403 does not momentarily increase the motor's speed or RPMs.

In step (3), control module 403 may receive one or more sensing signals from a sensor 413 situated within fractionation vessel 401, the sensing signals from sensor 413 indicating that the fluid has reached fluid level 423.

In step 504, control module 403 may reduce the speed or RPM of the motor in response to the sensing signal from sensor 413 in order to drive the pump at an RPM value that is lower than the previous RPM value until a fourth fluid level such as fluid level 424 is reached (or sensor 414 detects that the fluid has reached level 424). Although not shown, as in the previous steps, some embodiments may implement a preprogrammed time limitation whereby the motor's RPMs are gradually increased (and momentarily) until the next fluid level is reached.

In step (4), control module 403 may receive one or more sensing signals from sensor 414 situated within fractionation vessel 401, the sensing signals from sensor 414 concerning a fluid level 424.

In step 505, control module 403 may reduce the speed or RPM of the motor in response to the sensing signal from sensor 414 in order to drive the pump at a speed or RPM value that is still lower. Here, the purpose is to bring the fluid level somewhere between sensor 413 and sensor 414 so that ultimately an optimum fluid level 425 is reached. Accordingly, in step 505 control module 403 maintains the fluid level of the fluid medium at fluid level 425 or at a predetermined distance from collection compartment 418 of fractionation vessel 401.

In step (5) control module 403 may disable sensor 414 after a predetermined period of time of maintaining the fluid level at level 425. This is desirable so that the foam that starts to form and rise into collection compartment 418 does not inadvertently interfere or cause control module 403 to alter the motor's RPMs. During this step, control module 403 may continue to drive pump 402 at a constant RPM value in order to maintain the fluid level above the third sensor but below the fourth sensor, thereby facilitating the collection of the foam at step (6).

A system and method for foam fractionator automation has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A method performed by a control module for optimizing foam fractionation, comprising:
driving a pump motor to inject feed fluid into a fractionation vessel at an initial speed;
receiving sensing signals from a plurality of sensors configured to detect a fluid level of a fluid medium within the fractionation vessel;
continuously adjusting a speed of the motor in response to the sensing signals from the plurality of sensors;
maintaining the fluid level of the fluid medium at a predetermined distance from a collection compartment of the fractionation vessel; and
disabling at least one of the plurality of sensors for facilitating a foam to rise from the fluid medium into the collection compartment.

2. The method of claim 1, wherein receiving sensing signals from a plurality of sensors comprises:
receiving one or more signals from a safety-sensor coupled to the collection compartment of the fractionation vessel, the safety-sensor configured to detect the fluid medium and disregard the foam.

3. The method of claim 2, further comprising:
gradually decreasing the speed of the motor in response to the one or more signals from the safety-sensor to lower the fluid level of the fluid medium to a threshold level within the fractionation vessel.

4. The method of claim 1, wherein receiving the sensing signals from the plurality of sensors comprises:
receiving one or more sensing signals from a first sensor situated within the fractionation vessel, the sensing signals from the first sensor concerning a first fluid level of the feed fluid within the fractionation vessel.

5. The method of claim 4, wherein continuously adjusting the speed of the motor in response to the sensing signals from the plurality of sensors comprises:
reducing the initial speed of the motor in response to the sensing signal from the first sensor in order to drive the pump at a first speed lower than the initial speed of the motor.

6. The method of claim 5, wherein receiving the sensing signals from the plurality of sensors further comprises:
receiving one or more sensing signals from a second sensor situated within the fractionation vessel and above the first sensor, the sensing signals from the second sensor concerning a second fluid level within the fractionation vessel.

7. The method of claim 6, wherein continuously adjusting the speed of the motor in response to the sensing signals from the plurality of sensors further comprises:
reducing the first speed in response to the sensing signal from the second sensor in order to drive the pump at a second speed lower than the first speed value.

8. The method of claim 7, wherein receiving the sensing signals from the plurality of sensors further comprises:
receiving one or more sensing signals from a third sensor situated within a narrowing channel of the fractionation vessel and above the second sensor, the sensing signals from the third sensor concerning a third fluid level within the fractionation vessel.

9. The method of claim 8, wherein continuously adjusting the speed of the motor in response to the sensing signals from the plurality of sensors further comprises:
reducing the second speed in response to the sensing signal from the third sensor in order to drive the pump at a third speed lower than the second speed.

10. The method of claim 9, wherein receiving the sensing signals from the plurality of sensors further comprises:
receiving one or more sensing signals from a fourth sensor situated within the narrowing channel of the fractionation vessel and above the third sensor, the sensing signals from the fourth sensor concerning a fourth fluid level within the fractionation vessel.

11. The method of claim 10, wherein continuously adjusting the speed of the motor in response to the sensing signals from the plurality of sensors further comprises:
reducing the third speed in response to the sensing signal from the fourth sensor in order to drive the pump at a fourth speed lower than the third speed.

12. The method of claim 11, wherein disabling at least one of the plurality of sensors comprises:
disabling the fourth sensor after a predetermined period of time for maintaining the fluid level at the predetermined distance from the collection compartment of the fractionation vessel.

13. The method of claim 12, wherein facilitating the foam to rise from the fluid level into the collection compartment comprises:
driving the pump at a constant speed in order to maintain the fluid level above the third sensor but below the fourth sensor.

14. A system for optimizing foam fractionation, comprising:
a fractionation vessel;
a pump including a motor for delivering feed fluid to the vessel;
a plurality of sensors configured to detect a fluid level of a fluid medium within the fractionation vessel; and
a control module configured to:
drive the pump motor to inject the feed fluid into the fractionation vessel at an initial speed;
receive sensing signals from the plurality of sensors;
continuously adjust a speed of the motor in response to the sensing signals from the plurality of sensors; and
disable at least one of the plurality of sensors for:
maintaining the fluid level of the fluid medium at a predetermined distance from a collection compartment of the fractionation vessel, and
facilitating a foam to rise from the fluid medium into the collection compartment.

15. The system of claim 14, further comprising:
a safety-sensor coupled to the collection compartment of the fractionation vessel, the sensor configured to detect the fluid medium and disregard the foam, wherein the control module is further configured to gradually decrease the speed of the motor in response to the one or more signals from the safety-sensor to lower the fluid level of the fluid medium to a threshold level within the fractionation vessel.

16. The system of claim 14, further comprising:
a first sensor situated within the fractionation vessel, the sensing signals from the first sensor concerning a first fluid level of the feed fluid within the fractionation vessel, wherein the control module is further configured to reduce the initial speed of the motor in response to the sensing signal from the first sensor in order to drive the pump at a first speed that is lower than the initial speed of the motor.

17. The system of claim 16, further comprising:
a second sensor situated within the fractionation vessel and above the first sensor, the sensing signals from the second sensor concerning a second fluid level within the fractionation vessel, wherein the control module is further configured to reduce the first speed in response to the sensing signal from the second sensor in order to drive the pump at a second speed that is lower than the first speed of the motor.

18. The system of claim 17, further comprising:
a third sensor situated within a narrowing channel of the fractionation vessel and above the second sensor, the sensing signals from the third sensor concerning a third fluid level within the fractionation vessel, wherein the control module is further configured to reduce the second speed in response to the sensing signal from the third sensor in order to drive the pump at a third speed that is lower than the second speed of the motor.

19. The system of claim 18, further comprising:
a fourth sensor situated within the narrowing channel of the fractionation vessel and above the third sensor, the sensing signals from the fourth sensor concerning a fourth fluid level within the fractionation vessel, wherein the control module is further configured to reduce the third speed in response to the sensing signal from the fourth sensor in order to drive the pump at a fourth speed that is lower than the third speed of the motor.

20. The system of claim 19, wherein the control module is further configured to:
disable the fourth sensor after a predetermined period of time for maintaining the fluid level at the predetermined distance from the collection compartment of the fractionation vessel.
